(19) United States
(12) Patent Application Publication
(10) Pub. No.: US 2022/0391666 A1
(43) Pub. Date: Dec. 8, 2022

(54) Distributed Deep Learning System and Distributed Deep Learning Method

(71) Applicant: Nippon Telegraph and Telephone Corporation, Tokyo (JP)

(72) Inventors: Yuki Arikawa, Tokyo (JP); Kenji Tanaka, Tokyo (JP); Tsuyoshi Ito, Tokyo (JP); Kazuhiko Terada, Tokyo (JP); Takeshi Sakamoto, Tokyo (JP)

(21) Appl. No.: 17/776,869

(22) PCT Filed: Nov. 14, 2019
(86) PCT No.: PCT/JP2019/044672

§ 371 Date: May 13, 2022

(51) Int. Cl. G06N 3/04; H04L 12/54

(52) U.S. Cl. CPC G06N 3/04; H04L 12/5601; H04L 2012/5612

(57) ABSTRACT

A distributed deep learning system includes a plurality of calculation nodes connected to one another via a communication network. Each of the plurality of calculation nodes includes a computation unit that calculates a matrix product included in computation processing of a neural network and outputs a partial computation result, a storage unit that stores the partial computation result, and a network processing unit including a transmission unit that transmits the partial computation result to another calculation node, a reception unit that receives a partial computation result from another calculation node, an addition unit that obtains a total computation result, which is a sum of the partial computation result stored in the storage unit and the partial computation result from another calculation node, a transmission unit that transmits the total computation result to another calculation node, and a reception unit that receives a total computation result from another calculation node.

This patent application is a national phase filing under section 371 of PCI application no. PCT/JP2019/044672, filed on Nov. 14, 2019, which application is hereby incorporated herein by reference in its entirety.

### TECHNICAL FIELD

The present invention relates to a distributed deep learning system and a distributed deep learning method, and particularly relates to a distributed deep learning technique that is executed, in distributed coordination, by a plurality of calculation nodes that cooperate with one another in a network.

### BACKGROUND

In recent years, machine learning is utilized with respect to various types of information and data, and accordingly, the development of services and the provision of added values are actively underway. Machine learning at that time often requires a large amount of calculation resources. In particular, in machine learning that uses a neural network called deep learning, it is necessary to process a large amount of learning data in learning, which is a process for optimizing configuration parameters of the neural network. In order to increase the speed of this learning processing, one solution is to perform parallel processing on a plurality of computation apparatuses.

For example, NPL 1 discloses a distributed deep learning system in which four calculation nodes and an InfiniBand switch are connected via an InfiniBand network. Four GPUs (Graphics Processing Units) are installed in each calculation node. In the distributed deep learning system disclosed in NPL 1, an attempt to increase the speed is made by performing parallel processing with respect to learning computation with use of the four calculation nodes.

Also, NPL 2 discloses a configuration in which a calculation node (GPU server) in which eight GPUs are installed and an Ethernet® switch are connected via an Ethernet network. This NPL 2 discloses examples in which 1, 2, 4, 8, 16, 32, and 44 calculation nodes are used, respectively.

In a system disclosed in NPL 2, machine learning is performed using distributed synchronous SGD (Stochastic Gradient Descent). Specifically, machine learning is performed in the following procedure.

(1) Extract a part of learning data. A collection of the extracted learning data pieces is called a minibatch.

(2) The minibatch is divided so that the divided minibatches correspond in number to the GPUs, and the divided minibatches are allocated to respective GPUs.

(3) Each GPU obtains a loss function L(w), which serves as an index indicating a degree at which the values output from a neural network when the learning data allocated in (2) has been input deviate from the truth (referred to as “supervisory data”). In a process for obtaining this loss function, the output values are calculated in order from a layer on the input side toward a layer on the output side of the neural network; thus, this process is called forward propagation.

(4) Each GPU obtains partial differential values (gradients) under respective configuration parameters of the neural network (e.g., weights of the neural network) for the loss function value obtained in (3). In this process, the gradients under configuration parameters of each layer are calculated in order from a layer on the output side toward a layer on the input side of the neural network; thus, this process is called backpropagation.

(5) An average of the gradients that were respectively calculated by the GPUs is calculated.

(6) Using SGD (Stochastic Gradient Descent), each GPU updates each configuration parameter of the neural network so as to further reduce the loss function L(w) with use of the average value of the gradients calculated in (5). SGD is calculation processing for reducing the loss function L(w) by changing the value of each configuration parameter by a small amount in the gradient direction. By repeating this processing, the neural network is updated to a highly accurate neural network that has a small loss function L(w), that is to say, yields an output that is close to the truth.

Furthermore, NPL 3 discloses a distributed deep learning system configured in such a manner that 128 calculation nodes in which 8 GPUs are installed are connected via an InfiniBand network.

In any of the conventional distributed deep learning systems disclosed in NPL 1 to NPL 3, it is apparent that the speed of learning is increased and a learning period can be reduced as the number of calculation nodes increases. In this case, in order to calculate an average value of the configuration parameters of the neural network, such as the gradients calculated by respective calculation nodes, it is necessary to calculate, for example, the average value by exchanging these configuration parameters among the calculation nodes.

On the other hand, if the number of nodes is increased in order to increase the number of sets of parallel processing, necessary communication processing will immediately increase. When computation processing, such as calculation of an average value, and data exchange processing are performed on a calculation node with use of software as in the conventional techniques, there arises a problem that it is difficult to sufficiently increase the learning efficiency due to a large overhead associated with communication processing.

For example, NPL 3 discloses the relationship among a period required to perform 100 cycles of learning processing, a period required for communication among the aforementioned period, and the number of GPUs. According to this relationship, a period required for communication increases as the number of GPUs increases, and in particular, the period increases rapidly when the number of GPUs hits 512 or more.

### CITATION LIST

### Non Patent Literature

[NPL 1] Rengan Xu and Nishanth Dandapanthu. “Performance of Deep Learning by NVIDIA® Tesla® P100 GPU”. Dell Inc. 2016. http://ja.community.dell.com/techcenter/m/mediagallery/3765/download.
[NPL 2] Priya Goyal, Piotr Dollar, Ross Girshick, Pieter Noordhuis, Lukasz Wesolowski, Aapo Kyrola, Andrew Tulloch, Yangqing Jia, and Kaiming He. “Accurate, Large Minibatch SGD: Training ImageNet in 1 Hour”. Cornell University Library in the United States, arXiv:1706.02677. 2017. https://arxiv.org/abs/1706.02677.
[NPL 3] Takuya Akiba, Shuji Suzuki, and Keisuke Fukuda. “Extremely Large Minibatch SGD: Training ResNet-50 on ImageNet in 15 Minutes”. Cornell University Library in the United States, arXiv:1711.04325. 2017. https://arxiv.org/abs/1711.04325.

### SUMMARY

### Technical Problem

However, in the conventional distributed deep learning systems, if the number of calculation nodes connected to a communication network increases, there arises a problem that the increase in the speed of coordinated processing among the calculation nodes is suppressed.

Embodiments of the present invention have been made to solve the aforementioned problem, and it is an object thereof to perform coordinated processing among calculation nodes at high speed even if the number of calculation nodes connected to a communication network increases.

### Means for Solving the Problem

In order to solve the aforementioned problem, a distributed deep learning system according to embodiments of the present invention includes a plurality of calculation nodes that are connected to one another via a communication network, wherein each of the plurality of calculation nodes includes a computation apparatus that calculates a matrix product included in computation processing of a neural network, and outputs a first computation result, a first storage apparatus that stores the first computation result output from the computation apparatus, and a network processing apparatus including a first transmission circuit that transmits the first computation result stored in the first storage apparatus to another calculation node, a first reception circuit that receives a first computation result from another calculation node, an addition circuit that obtains a second computation result, the second computation result being a sum of the first computation result stored in the first storage apparatus and the first computation result from the another calculation node received by the first reception circuit, a second transmission circuit that transmits the second computation result to another calculation node, and a second reception circuit that receives a second computation result from another calculation node.

In order to solve the aforementioned problem, a distributed deep learning system according to embodiments of the present invention includes: a plurality of calculation nodes that are connected to one another via a communication network; and an aggregation node, wherein each of the plurality of calculation nodes includes a computation apparatus that calculates a matrix product included in computation processing of a neural network, and outputs a first computation result, a first network processing apparatus including a first transmission circuit that transmits the first computation result output from the computation apparatus to the aggregation node, and a first reception circuit that receives a second computation result from the aggregation node, the second computation result being a sum of first computation results calculated by the plurality of calculation nodes, and a first storage apparatus that stores the second computation result received by the first reception circuit, the aggregation node includes a second network processing apparatus including a second reception circuit that receives the first computation results from the plurality of calculation nodes, an addition circuit that obtains the second computation result which is the sum of the first computation results received by the second reception circuit, and a second transmission circuit that transmits the second computation result obtained by the addition circuit to the plurality of calculation nodes, and a second storage apparatus that stores the first computation results from the plurality of calculation nodes received by the second reception circuit, and the addition circuit reads out the first computation results from the plurality of calculation nodes stored in the second storage apparatus, and obtains the second computation result.

In order to solve the aforementioned problem, a distributed deep learning method according to embodiments of the present invention is a distributed deep learning method executed by a distributed deep learning system including a plurality of calculation nodes that are connected to one another via a communication network, wherein each of the plurality of calculation nodes performs a computation step of calculating a matrix product included in computation processing of a neural network, and outputting a first computation result, a first storage step of storing the first computation result output in the computation step to a first storage apparatus, and a network processing step including a first transmission step of transmitting the first computation result stored in the first storage apparatus to another calculation node, a first reception step of receiving a first computation result from another calculation node, an addition step of obtaining a second computation result, the second computation result being a sum of the first computation result stored in the first storage apparatus and the first computation result from the another calculation node received in the first reception step, a second transmission step of transmitting the second computation result to another calculation node, and a second reception step of receiving a second computation result from another calculation node.

In order to solve the aforementioned problem, a distributed deep learning method according to embodiments of the present invention is a distributed deep learning method executed by a distributed deep learning system including a plurality of calculation nodes that are connected to one another via a communication network, and an aggregation node, wherein each of the plurality of calculation nodes performs a computation step of calculating a matrix product included in computation processing of a neural network, and outputting a first computation result, a first network processing step including a first transmission step of transmitting the first computation result output in the computation step to the aggregation node, and a first reception step of receiving a second computation result from the aggregation node, the second computation result being a sum of first computation results calculated by the plurality of calculation nodes, and a first storage step of storing the second computation result received in the first reception step to a first storage apparatus, the aggregation node performs a second network processing step including a second reception step of receiving the first computation results from the plurality of calculation nodes, an addition step of obtaining the second computation result which is the sum of the first computation results received in the second reception step, and a second transmission step of transmitting the second computation result obtained in the addition step to the plurality of calculation nodes, and a second storage step of storing, to a second storage apparatus, the first computation results from the plurality of calculation nodes received in the second reception step, and in the addition step, the first computation results from the plurality of calculation nodes stored in the second storage apparatus are read out, and the second computation result is obtained.

### Effects of Embodiments of the Invention

According to embodiments of the present invention, each of a plurality of calculation nodes that are connected to one another via a communication network includes a network processing apparatus including an addition circuit that obtains a second computation result, which is a sum of a first computation result that has been stored in a first storage apparatus and output from a computation apparatus, and a first computation result from another calculation node received by a first reception circuit. Therefore, even if the number of calculation nodes connected to the communication network increases, coordinated processing among the calculation nodes can be performed at higher speed.

### BRIEF DESCRIPTION OF THE DRAWINGS

FIG. 1 is a block diagram showing a configuration of a distributed deep learning system according to a first embodiment of the present invention.

FIG. 2 is a diagram for describing learning processing of a neural network.

FIG. 3 is a diagram for describing an example of calculation for a hidden layer.

FIG. 4 is a diagram for describing an example of calculation for a hidden layer.

FIG. 5 is a diagram for describing weight parameters that are stored in a state where the weight parameters are divided among storage units of a plurality of calculation nodes.

FIG. 6 is a block diagram showing a configuration of a calculation node according to a conventional example.

FIG. 7 is a block diagram showing one example of a hardware configuration of the calculation nodes according to the first embodiment.

FIG. 8 is a flowchart for describing the operations of the calculation nodes according to the first embodiment.

FIG. 9 is a sequence diagram for describing the operations of the distributed deep learning system according to the first embodiment.

FIG. 10 is a block diagram showing a configuration of a distributed deep learning system according to a second embodiment.

FIG. 11 is a block diagram showing a configuration of calculation nodes according to the second embodiment.

FIG. 12 is a block diagram showing a configuration of an aggregation node according to the second embodiment.

FIG. 13 is a block diagram showing one example of a configuration of the aggregation node according to the second embodiment.

FIG. 14 is a flowchart for describing the operations of the calculation nodes according to the second embodiment.

FIG. 15 is a flowchart for describing the operations of the aggregation node according to the second embodiment.

FIG. 16 is a sequence diagram for describing the operations of the distributed deep learning system according to the second embodiment.

### DETAILED DESCRIPTION OF ILLUSTRATIVE EMBODIMENTS

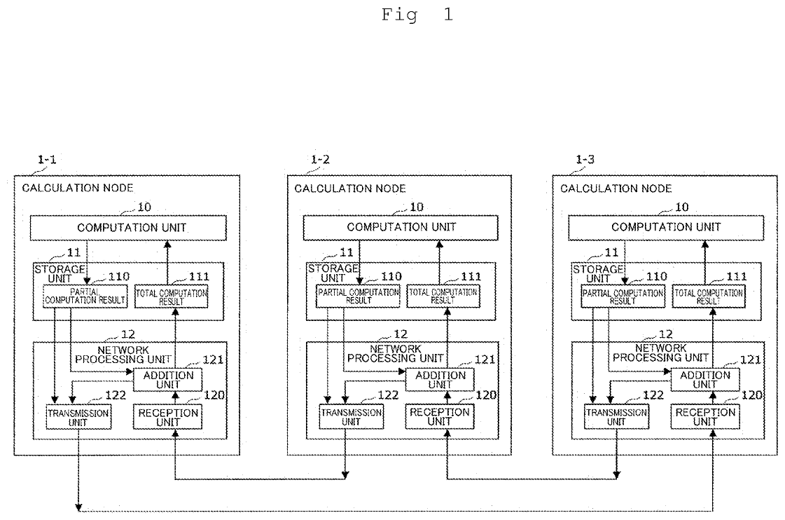

The following describes preferred embodiments of the present invention in detail with reference to FIG. 1 to FIG. 16.

### Overview of Embodiments of the Invention

First, an overview of a distributed deep learning system according to the embodiments of the present invention will be described with reference to FIG. 1 to FIG. 5. As shown in FIG. 1, the distributed deep learning system according to the embodiments of the present invention includes a plurality of calculation nodes 1-1 to 1-3 that are connected via a communication network. Each of the plurality of calculation nodes 1-1 to 1-3 calculates a part of matrix products included in computation processing of a neural network, and obtains a sum of the result of calculation of matrix products calculated by the self-node and the result of calculation of matrix products received from another calculation node 1. Furthermore, each of the plurality of calculation nodes 1-1 to 1-3 distributes the obtained sum of the results of calculation of matrix products to another calculation node 1.

One of the characteristics of the distributed deep learning system according to the present embodiments is that each of the plurality of calculation nodes 1-1 to 1-3 includes, in a network processing apparatus that exchanges data, an addition circuit that obtains a sum of the result of calculation in the self-node and the result of calculation from another calculation node 1.

Note that in the following description, the calculation nodes 1-1 to 1-3 may be collectively referred to as calculation nodes 1. Also, although each of the drawings including FIG. 1 will be described in connection with a case where the distributed deep learning system includes three calculation nodes 1-1 to 1-3 for the sake of simple explanation, N calculation nodes 1 (N is any number satisfying N≥2) can be used.

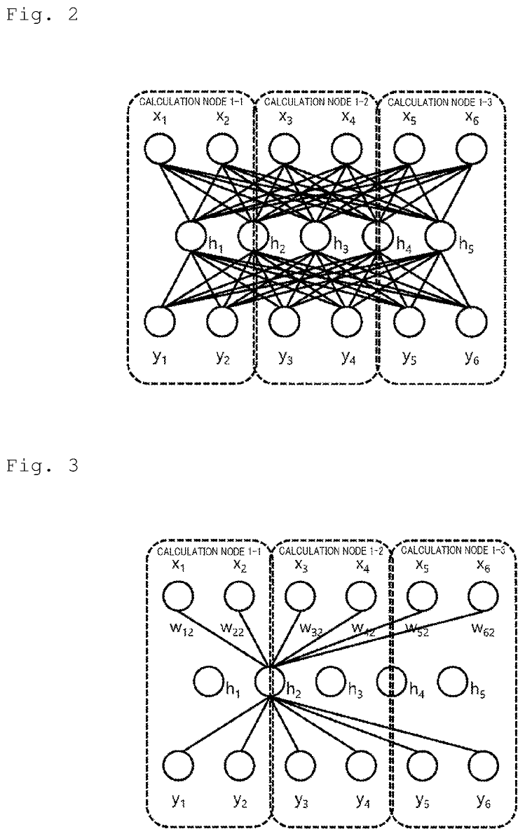

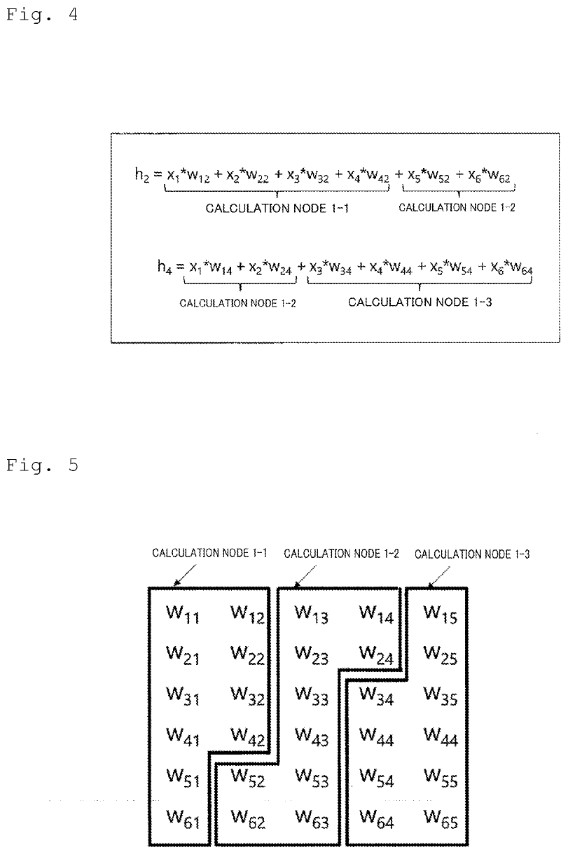

FIG. 2 shows one example of learning processing of the neural network, which is performed using the distributed deep learning system according to embodiments of the present invention. FIG. 3 shows one example of calculation of hidden layers in the learning processing of the neural network, which is performed using the distributed deep learning system according to embodiments of the present invention. FIG. 4 shows an example in which the execution of calculation of the hidden layers in the learning processing of the neural network, which is performed using the distributed deep learning system according to embodiments of the present invention, is divided among a plurality of calculation nodes. FIG. 5 shows an example in which weight parameters that are used when the learning processing of the neural network is performed using the distributed deep learning system of embodiments of the present invention are stored in a state where the weight parameters are divided among a plurality of calculation nodes 1.

In the distributed deep learning system of embodiments of the present invention, training for learning the values of the weights of the neural network with use of learning data in deep learning is performed throughout the entire distributed deep learning system. Specifically, each calculation node 1, which is a learning node, performs predetermined computation processing of the neural network with use of learning data and the neural network, and calculates the gradient of weight data. At the time of completion of this predetermined computation, the plurality of different calculation nodes 1 have different gradients of weight data.

For example, a network processing apparatus, which is realized also by, for example, a computing interconnect apparatus connected to the communication network, aggregates the gradients of weight data, performs processing for averaging the aggregated data, and distributes the result thereof to each calculation node 1 again. Using the average gradient of weight data, each calculation node 1 performs predetermined computation processing of the neural network again with use of learning data and the neural network. By repeating this processing, the distributed deep learning system obtains a learned neural network model.

The calculation nodes 1 have a learning function of calculating the output values of the neural network, which is a mathematical model constructed in the form of software, and further improving the accuracy of the output values by updating configuration parameters of the neural network in accordance with learning data.

The neural network is constructed inside each calculation node 1. As a method of realizing the calculation nodes 1, the calculation nodes 1 may be realized using software on a CPU or a GPU, or may be realized using an LSI (Large Scale Integration) circuit formed as an FPGA (Field Programmable Gate Array) or an ASIC (Application Specific Integrated Circuit). Note that a specific example of a hardware configuration of the calculation nodes 1 will be described later.

FIG. 2 exemplarily shows a case where outputs y₁ to y₆ are obtained by calculating hidden layers (h₁ to h₅) with respect to inputs x₁ to x₆ with use of the three calculation nodes 1-1 to 1-3 included in the distributed deep learning system. The example of FIG. 2 presents a model parallel method in which the model of the neural network is divided among the plurality of calculation nodes 1. In general, this method is used when learning a large-scale neural network with weight parameters that do not fit within one calculation node 1.

As shown in FIG. 3, when the outputs of the hidden layers are to be obtained, a multiply-accumulate operation is performed with respect to the inputs x and the weights w, which are parameters indicating the magnitude relationships among the inputs x and the hidden layers h; as a result, the outputs of the hidden layers h are obtained. For example, when the outputs of the hidden layer h₂ are to be obtained, a multiply-accumulate operation is performed with respect to the inputs x₁ to x₆ and the weights w₁₂ to w₆₂; as a result, the outputs of the hidden layer h₂ are obtained.

When the model parallel method is used in which the model of the neural network is divided among the plurality of calculation nodes 1 as stated earlier, the outputs of the hidden layer h₂ are calculated by both of the calculation node 1-1 and the calculation node 1-2, specifically, as shown in FIG. 4. The outputs of the hidden layer h₂ are calculated by adding the results of calculations that were respectively performed in the calculation nodes 1-1 and 1-2. At this time, group communication is performed to add the results of calculations that were respectively performed in the calculation nodes 1. It is an object of embodiments of the present invention to increase the speed of this group communication.

In embodiments of the present specification, the result of calculation of a part of matrix products included in the computation processing of the neural network, which was calculated by each calculation node 1, is referred to as a “partial computation result” (first computation result), and a sum of the partial computation results is referred to as a “total computation result” (second computation result).

Similarly, the outputs of the hidden layer h₄ are calculated by both of the calculation node 1-2 and the calculation node 1-3. Also, with regard to the outputs of the hidden layers h₁, h₃, and h₅, the computation is completed without being shared among a plurality of calculation nodes 1.

FIG. 5 shows weight parameters w that are held by the plurality of calculation nodes 1-1 to 1-3. The number of weight parameters w that can be held by each of the calculation nodes 1-1 to 1-3 is determined by the capacity of a usable memory provided for each of the calculation nodes 1-1 to 1-3. Therefore, if the model of the neural network increases in size, the number of weight parameters w increases as well, and respective calculation nodes 1-1 to 1-3 may become incapable of holding weight parameters w of the entire neural network. In this case, as shown in FIG. 5, weight parameters w₁₁ to w₆₅ of the neural network to be learned are held in a state where the weight parameters are divided among respective calculation nodes 1-1 to 1-3.

### First Embodiment

Next, a description is given of a distributed deep learning system according to a first embodiment of the present invention.

As shown in FIG. 1, the distributed deep learning system includes a plurality of calculation nodes 1-1 to 1-3. The plurality of calculation nodes 1-1 to 1-3 are connected via a ring communication network. Also, the plurality of calculation nodes 1-1 to 1-3 according to the present embodiment are connected via the communication network that enables bidirectional communication.

### Function Blocks of Calculation Nodes

As shown in FIG. 1, each of the calculation nodes 1-1 to 1-3 includes a computation unit (computation apparatus) 10, a storage unit (first storage apparatus and second storage apparatus) 11, and a network processing unit (network processing apparatus) 12.

The computation unit 10 calculates a part of matrix products of the neural network, and outputs a partial computation result. As described using FIG. 4 and FIG. 5, the computation unit 10 calculates matrix products with use of the weight parameters w of the neural network held by the self-node and the inputs x or the outputs of a hidden layer h. The outputs of a hidden layer h are a total computation result 111 held in the storage unit 11, and are shared with another calculation node 1.

The storage unit 11 includes a region that holds a partial computation result (first storage apparatus) 110 and a total computation result (second storage apparatus) ill. Also, the storage unit 11 holds partial weight parameters w included among the weight parameters w of the neural network.

The partial computation result 110 stores the partial computation result output from the computation unit 10.

The total computation result 111 stores a total computation result obtained by the self-node, and a total computation result received from another calculation node 1.

The network processing unit 12 includes a reception unit (first reception circuit and second reception circuit) 120, an addition unit (addition circuit) 121, and a transmission unit (first transmission circuit and second transmission circuit) 122.

The reception unit 120 receives a partial computation result from another calculation node 1 via the communication network. Also, the reception unit 120 receives a total computation result from another calculation node 1.

The addition unit 121 obtains a total computation result by adding the partial computation result from another calculation node 1, which was received by the reception unit 120, and the partial computation result calculated by the self-node. The addition unit 121 can be configured using, for example, an addition circuit that uses a logic circuit. The total computation result obtained by the addition unit 121 is stored to the storage unit 11.

The transmission unit 122 transmits the partial computation result stored in the storage unit 11, which was calculated by the computation unit 10 of the self-node, to another calculation node 1 via the communication network. Also, the transmission unit 122 distributes the total computation result obtained by the addition unit 121 to another calculation node 1 via the communication network.

Note that each of the plurality of calculation nodes 1-1 to 1-3 has a similar functional configuration.

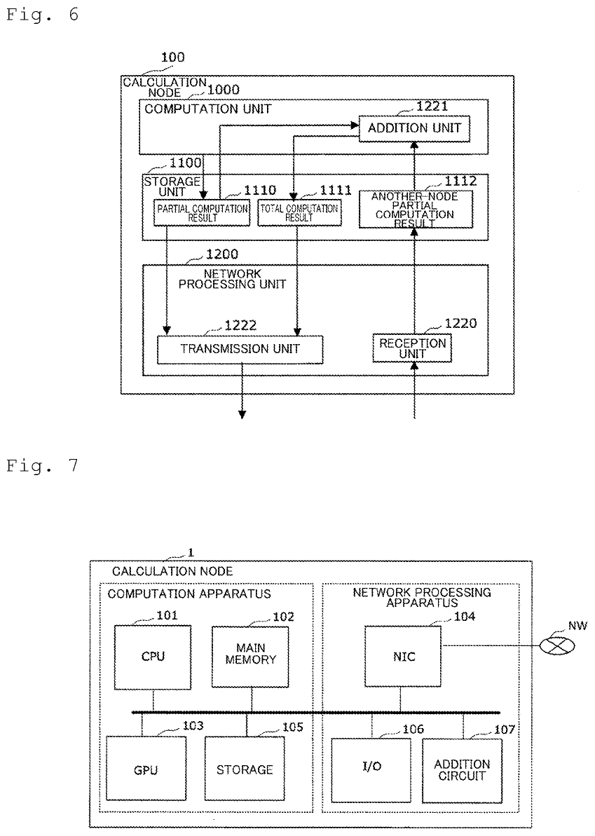

A description is now given of the configuration of the calculation nodes 1 included in the distributed deep learning system according to the present embodiment and the configuration of a calculation node 100 included in a distributed deep learning system of a conventional example, which is shown in FIG. 6, in comparison with each other.

As shown in FIG. 6, the calculation node 100 according to the conventional example includes a computation unit 1000, a storage unit 1100, and a network processing unit 1200. As described using FIG. 1, the calculation nodes 1 of the present embodiment include the addition unit 121 that obtains a sum of a partial computation result that the network processing unit 12 received from another calculation node 1 and a partial computation result calculated by the self-node. However, in the calculation node 100 of the conventional example, the computation unit 1000 includes an addition unit 1221.

In the calculation node 100 of the conventional example, a partial computation result received from another calculation node 100 is stored to an another-node partial computation result 1112 in the storage unit 1100. In order to obtain a total computation result, the addition unit 1221 included in the computation unit 1000 makes a memory access with respect to a memory that composes the storage unit 1100, which creates an additional memory access period. Therefore, the entire processing period also becomes long compared to the configuration of the present embodiment.

In contrast, in the calculation nodes 1 according to the present embodiment, the sum of the partial computation result received from another calculation node 1 and the partial computation result calculated by the self-node is calculated by the addition unit 121 included in the network processing unit 12, and thus the additional memory access period, which is created on the calculation node 100 of the conventional example, is not created.

### Hardware Configuration of Calculation Nodes

Next, one example of a hardware configuration that realizes the calculation nodes 1 provided with the aforementioned functions will be described with reference to a block diagram of FIG. 7.

As shown in FIG. 7, the calculation nodes 1 can be realized, for example, by a computer that includes a CPU 101, a main memory 102, a GPU 103, an NIC 104, a storage 105, and an I/O 106, and by a program that controls these hardware resources.

A program that is intended for the CPU 101 and the GPU 103 to perform various types of control and computation is stored in the main memory 102 in advance. The CPU 101, the GPU 103, and the main memory 102 realize respective functions of the calculation nodes 1, such as the computation unit 10 and the addition unit 121 shown in FIG. 1.

The NIC 104 is an interface circuit for network connection among the calculation nodes 1, and with various types of external electronic devices. The NIC 104 realizes the reception unit 120 and the transmission unit 122 of FIG. 1. The NIC 104 can use an inter-device interface compatible with, for example, communication via 100 Gbit Ethernet®.

The storage 105 includes a readable and writable storage medium, and a driving apparatus for reading and writing various types of information, such as programs and data, from and to this storage medium. For the storage 105, a semiconductor memory, such as a hard disk and a flash memory, can be used as the storage medium. The storage 105 realizes the storage unit 11 described using FIG. 1.

The storage 105 includes a program storage region for storing a program that is intended for the calculation node 1 to execute distributed deep learning processing, such as computation of the neural network including matrix products. The storage 105 may include, for example, a backup region and the like for backing up the aforementioned data, programs, and so forth.

The I/O 106 includes a network port to which signals from external devices are input and which outputs signals to external devices. As the network port, for example, two or more network ports can be used.

The addition circuit 107 can use, for example, an addition circuit including a basic logic gate and the like. The addition circuit 107 realizes the addition unit 121 described using FIG. 1. Note that in the present embodiment, the addition circuit 107 is included in the network processing apparatus that includes the NIC 104 and the I/O 106. Furthermore, the computation apparatus includes the CPU 101, the main memory 102, the GPU 103, and the storage 105.

For example, a broadband network, such as 100 Gbit Ethernet, is used as the communication network NW according to the present embodiment.

### Operations of Calculation Nodes

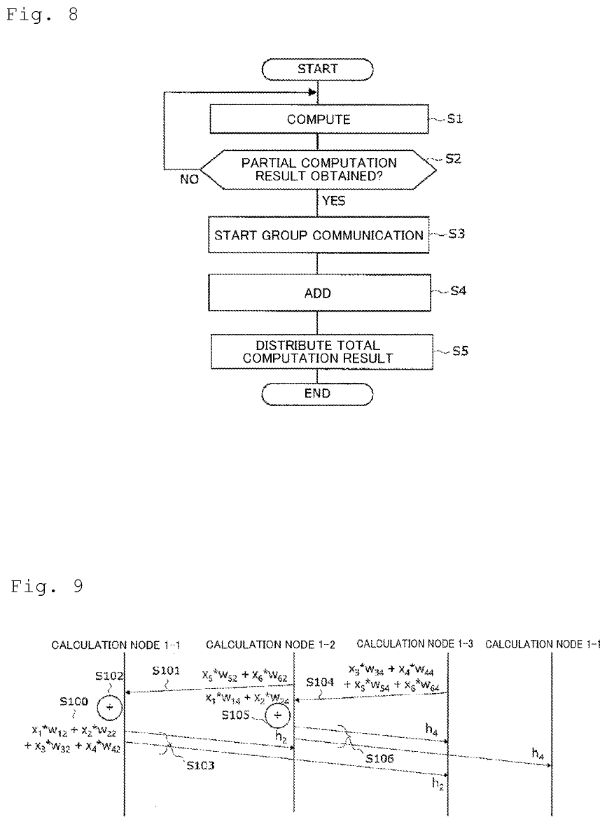

First, the operations of each calculation node 1 configured in the aforementioned manner will be described using a flowchart of FIG. 8. In the following description, a part of the neural network model, inputs x, and weight parameters w are loaded to the storage unit 11 in advance.

First, the computation unit 10 calculates a part of matrix products in learning of the neural network (step S1).

Next, once a partial computation result obtained by the computation unit 10 has been stored to the storage unit 11 (step S2: YES), the network processing unit 12 starts group communication (step S3). On the other hand, when the partial computation result calculated by the self-node has not been obtained (step S2: NO), computation in step S1 is executed (step S1).

For example, assume a case where the distributed deep learning system is a synchronous system. In the synchronous system, at the timing of completion of the calculation of parts of matrix products in all of the calculation nodes 1-1 to 1-3, the obtained partial computation results are shared via group communication. Therefore, the calculation nodes 1-1 to 1-3 hold the partial computation result calculated by the self-node in the storage unit 11 until a predetermined timing arrives.

Note that also in the case of the synchronous system, it is not necessarily required to wait for the completion of calculation by the computation units 10 of all calculation nodes 1-1 to 1-3; for example, the timing of completion of calculation by a part of the calculation nodes 1 of the distributed deep learning system may be used.

For example, as the hidden layer h₂ can be obtained at the time of completion of calculations by the calculation node 1-1 and the calculation node 1-2, group communication may be started without waiting for the completion of calculation by the calculation node 1-3.

On the other hand, when the distributed deep learning system adopts an asynchronous system in which group communication is started without waiting for the completion of computation by another calculation node 1, group communication with a predetermined calculation node 1 is started at the time of completion of calculation of a partial computation result by each of the calculation nodes 1-1 to 1-3. In this case, in the calculation node 1 that has received data of partial computation results, the received partial computation results are temporarily accumulated in the storage unit 11 until the calculation of partial computation is completed in the self-node.

Once the network processing unit 12 has started group communication in step S3, the transmission unit 122 transmits the partial computation result calculated by the self-node to another calculation node 1 via the communication network. Also, the reception unit 120 receives a partial computation result calculated by another calculation node 1. At this time, as shown in FIG. 1, the transmission unit 122 transmits the partial computation result by using a preset another calculation node 1 as a transmission destination. Also, the reception unit 120 receives the partial computation result from the preset another calculation node 1 connected via the network.

Next, the addition unit 121 obtains a total computation result, which is a sum of the partial computation result obtained by the self-node and the partial computation result received from another calculation node 1 (step S4).

Next, the network processing unit 12 distributes the total computation result obtained in step S4 to another calculation node 1 (step S5). Specifically, the transmission unit 122 transmits the total computation result obtained by the addition unit 121 to another calculation node 1 via the communication network. Thereafter, the total computation result, which is the sum of the partial computation results calculated in each of the plurality of calculation nodes 1-1 to 1-3, is stored to the storage unit 11.

### Operations of Distributed Deep Learning System

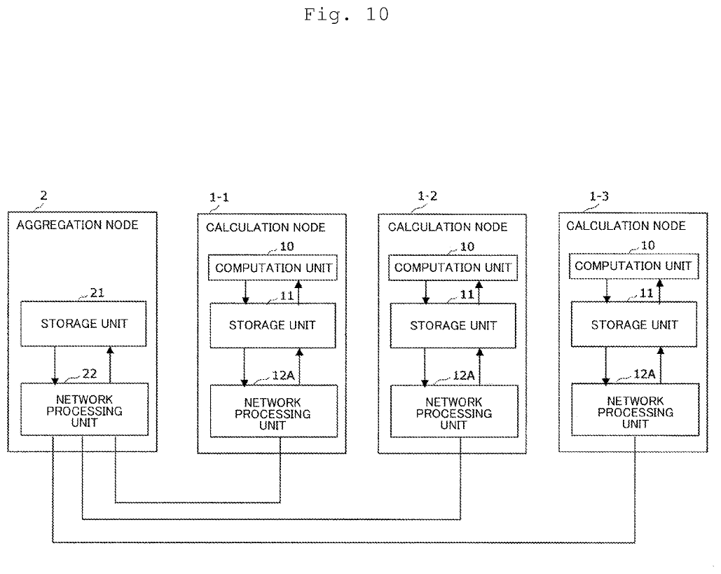

Next, the operations of the distributed deep learning system will be described with reference to a sequence diagram of FIG. 9.

As described using FIG. 5, the calculation node 1-1 holds the weight parameters w₁₂ to w₄₂ indicating the combinations of the inputs x₁ to x₄ and the hidden layer h₂. On the other hand, the calculation node 1-2 holds the weight parameters w₅₂ and w₆₂ associated with other inputs x₅ and x₆ and the hidden layer h₂.

Similarly, as described using FIG. 5, the calculation node 1-2 holds the weight parameters w₁₄ to w₂₄ indicating the combinations of the inputs x₁ and x₂ and the hidden layer h₄. On the other hand, the calculation node 1-3 holds the weight parameters w₃₄ to w₆₄ associated with other inputs x₃ to x₆ and the hidden layer h₄.

As shown in FIG. 9, the computation unit 10 of the calculation node 1-1 obtains a partial computation result by calculating [x₁*w₁₂+x₂*w₂₂+x₃*w₃₂+x₄*w₂₄] (step S100). On the other hand, the computation unit 10 of the calculation node 1-2 obtains partial computation results by calculating [x₅*w₅₂+x₆*w₆₂] and [x₁*w₁₄+x₂*w₂₄]. The calculation node 1-2 transmits the partial computation result [x₅*w₅₂+x₆*w₆₂] to the calculation node 1-1 (step S101).

Next, in the calculation node 1-1, the addition unit 121 of the network processing unit 12 obtains a total computation result by adding the partial computation result obtained by the self-node and the partial computation result transmitted from the calculation node 1-2 (step S102). As a result, the total computation result indicating the outputs of the hidden layer h₂ is obtained.

Thereafter, the transmission unit 122 of the calculation node 1-1 distributes the outputs of the hidden layer h₂ to other calculation nodes 1-2 and 1-3 (step S103).

On the other hand, the computation unit 10 of the calculation node 1-3 obtains a partial computation result by calculating [x₃*w₃₄+x₄*w₄₄+x₅*w₅₄+x₆*w₆₄], and transmits the partial computation result to the calculation node 1-2 (step S104). Next, the addition unit 121 of the calculation node 1-2 obtains a total computation result by adding the partial computation result representing the calculation [x₁*w₁₄+x₂*w₂₄] associated with h₄, which was obtained in step S101, and the partial computation result received from the calculation node 1-3 (step S105). The total computation result obtained in step S105 indicates the outputs of the hidden layer h₄.

Thereafter, the calculation node 1-2 distributes the total computation result obtained in step S105 to other calculation nodes 1-1 and 1-3 (step S106).

Through the aforementioned steps, the outputs of the hidden layers h₂ and h₄ are obtained as the sums of partial computation results, and this obtainment is shared among the plurality of calculation nodes 1-1 to 1-3.

On the other hand, as shown in FIG. 5, with regard to the outputs of the hidden layer h₁, a partial computation result obtained only by the calculation node 1-1, which holds the weight parameters w₁₁ to w₆₁, is obtained as a total computation result representing the outputs. Also, the outputs of the hidden layer h₃ are similarly obtained only by the calculation node 1-2, which holds the weight parameters w₁₃ to w₆₃. Furthermore, the outputs of the hidden layer h₅ are obtained only by the calculation node 1-3, which holds the weight parameters w₁₅ to w₆₅.

Here, as shown in FIG. 9, in the distributed deep learning system according to the present embodiment, a transmission of a partial computation result obtained by the self-node, a reception of a partial computation result from another calculation node 1, and an exchange of a total computation result are executed in different communication directions.

For example, assume a case where respective calculation nodes 1-1 to 1-3 are connected via a ring communication network with use of 100 Gbit Ethernet as stated earlier. In this case, the maximum communication speed is 100 Gbps when only one-way communication is used, whereas the maximum communication speed is 100 Gbps*2=200 Gbps when a bidirectional communication band is used.

Also, in the present embodiment, using communication packets, the transmission unit 122 transmits a partial computation result calculated by the self-node to another calculation node 1, and the reception unit 120 can receive a partial computation result from another calculation node 1. In this case, a communication packet includes an identifier for determining whether the partial computation result is addressed to the self-node.

For example, whether data is addressed to the self-node can be distinguished based on whether a flag is set in a bit location that varies with each of the calculation nodes 1-1 to 1-3 in a header of a communication packet. When a flag is set in a bit location for the self-node in a header of a communication packet received by the reception unit 120, it is determined that a partial computation result included in the received communication packet is data addressed to the self-node. Then, a total computation result, which is the sum of the partial computation result calculated by the self-node and the received partial computation result from another calculation node 1, is obtained.

Furthermore, when the execution of processing is shared among the plurality of calculation nodes 1-1 to 1-3, it is also possible to define the master-subordinate relationship among the calculation nodes 1-1 to 1-3. For example, it is possible to adopt a configuration in which the calculation node 1-1, which calculates partial computation with use of a weight parameter w₁ₙ is used as a master calculation node, and other calculation nodes 1-2 and 1-3 transmit a partial computation result to the master calculation node 1-1.

As described above, according to the first embodiment, each of the plurality of calculation nodes 1-1 to 1-3 includes the network processing unit 12 that includes the transmission unit 122, the reception unit 120, and the addition unit 121. Here, this transmission unit 122 transmits a partial computation result obtained by the self-node to another calculation node 1. Also, this reception unit 120 receives a partial computation result from another calculation node 1. Furthermore, this addition unit 121 performs total computation to obtain a sum of the partial computation result from another calculation node 1, which was received by the reception unit 120, and the partial computation result from the self-node.

Therefore, the computation unit 10 no longer needs to perform computation of addition, and reading and writing of a memory associated therewith can be reduced; as a result, even if the number of calculation nodes 1 connected to the communication network increases, coordinated processing among the calculation nodes 1 can be performed at higher speed.

### Second Embodiment

Next, a description is given of a second embodiment of the present invention. Note that in the following description, the same reference signs are given to the constituents that are the same as those of the first embodiment described above, and a description thereof is omitted.

The first embodiment has been described in connection with a case where each of the plurality of calculation nodes 1-1 to 1-3 includes the network processing unit 12 that includes the addition unit 121, and the network processing unit 12 performs processing for adding a partial computation result obtained by the self-node and a partial computation result received from another calculation node 1. In contrast, in the second embodiment, a distributed deep learning system includes an aggregation node 2 that aggregates partial computation results that were respectively obtained by a plurality of calculation nodes 1-1 to 1-3, and performs addition processing. The following description will be provided with a focus on the constituents that differ from the first embodiment.

### Configuration of Distributed Deep Learning System

FIG. 10 is a block diagram showing an exemplary configuration of a distributed deep learning system according to the present embodiment. The distributed deep learning system includes a plurality of calculation nodes 1-1 to 1-3 and an aggregation node 2 that are connected via a communication network.

As shown in FIG. 10, for example, three calculation nodes 1-1 to 1-3 and one aggregation node 2 are connected via a star communication network. In the present embodiment, the plurality of calculation nodes 1-1 to 1-3 and the aggregation node 2 calculate matrix products of a neural network.

### Function Blocks of Calculation Nodes

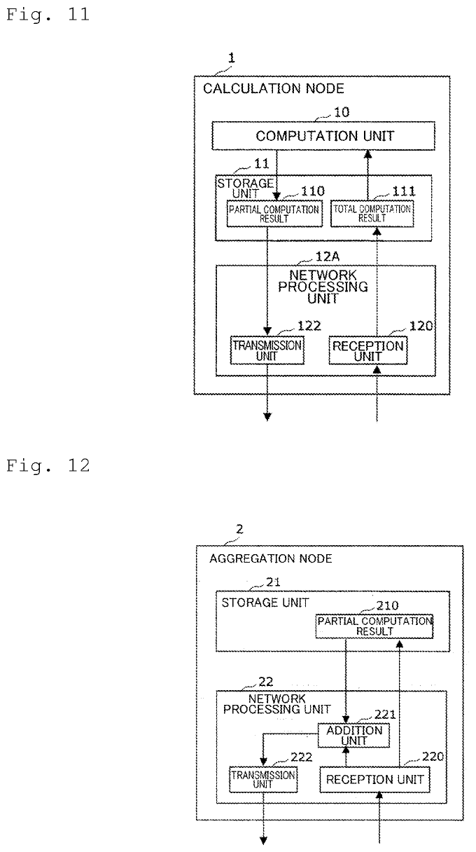

As shown in block diagrams of FIG. 10 and FIG. 11, each of the calculation nodes 1-1 to 1-3 includes a computation unit (computation apparatus) 10, a storage unit (first storage apparatus) 11, and a network processing unit (first network processing apparatus) 12A.

The computation unit 10 calculates a part of matrix products for learning of the neural network, and outputs a partial computation result.

The storage unit 11 stores the partial computation result 110 of the self-node, which was obtained by the computation unit 10, and a total computation result 111.

The network processing unit 12A includes a reception unit (first reception circuit) 120 and a transmission unit (first transmission circuit) 122.

The reception unit 120 receives a total computation result, which is a sum of partial computation results calculated by a plurality of calculation nodes 1, from the later-described aggregation node 2.

The transmission unit 122 transmits the partial computation result obtained by the self-node to the aggregation node 2 via the communication network.

### Function Blocks of Aggregation Node

As shown in FIG. 10 and FIG. 12, the aggregation node 2 includes a storage unit (second storage apparatus) 21 and a network processing unit (second network processing apparatus) 22. The aggregation node 2 aggregates the partial computation results calculated by the plurality of calculation nodes 1-1 to 1-3, performs total computation including addition processing, and distributes the obtained total computation result to the plurality of calculation nodes 1-1 to 1-3.

The storage unit 21 stores the partial computation results 210 that were respectively obtained by the calculation nodes 1-1 to 1-3.

The network processing unit 22 includes a reception unit (second reception circuit) 220, an addition unit (addition circuit) 221, and a transmission unit (second transmission circuit) 222.

The reception unit 220 receives the partial computation results respectively from the plurality of calculation nodes 1-1 to 1-3. The received partial computation results are stored to the storage unit 21.

The addition unit 221 obtains a total computation result, which is a sum of predetermined partial computation results included among the partial computation results from the plurality of calculation nodes 1-1 to 1-3 received by the reception unit 220. The addition unit 221 can be configured using, for example, an addition circuit that uses a logic circuit.

For example, using the specific example that has been described based on FIG. 2 to FIG. 5, the outputs of the hidden layer h₂ are obtained by adding the partial computation results obtained by the calculation nodes 1-1 and 1-2. The addition unit 221 adds the partial computation results that were respectively obtained by the calculation nodes 1-1 and 1-2, thereby obtaining a total computation result as the outputs of the hidden layer h₂.

The transmission unit 222 distributes the total computation result obtained by the addition unit 221 to the plurality of calculation nodes 1-1 to 1-3.

### Hardware Configuration of Aggregation Node

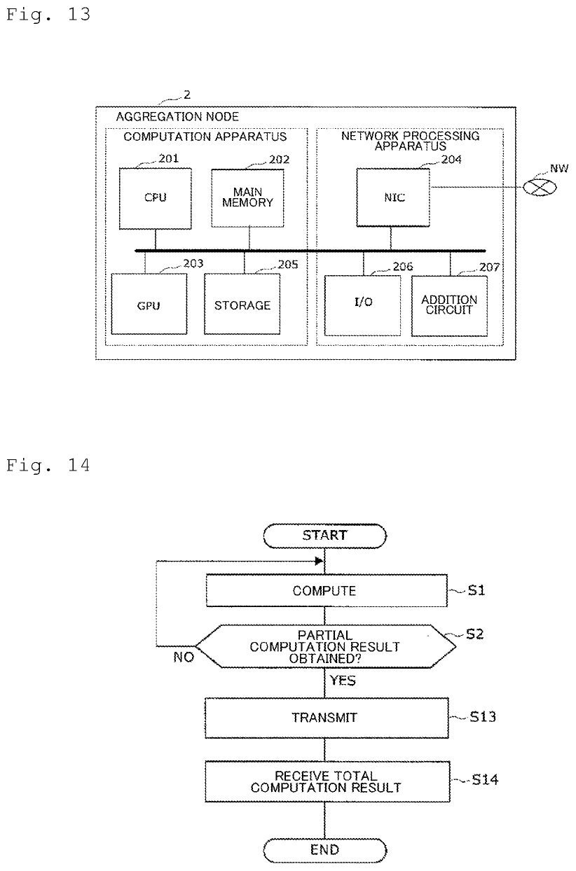

Next, one example of a hardware configuration that realizes the aggregation node 2 provided with the aforementioned functions will be described with reference to a block diagram of FIG. 13.

As shown in FIG. 13, the aggregation node 2 can be realized, for example, by a computer that includes a CPU 201, a main memory 202, a GPU 203, an NIC 204, a storage 205, and an I/O 206, and by a program that controls these hardware resources.

A program that is intended for the CPU 201 and the GPU 203 to perform various types of control and computation is stored in the main memory 202 in advance. The CPU 201, the GPU 203, and the main memory 202 realize respective functions of the aggregation node 2, such as the addition unit 221 shown in FIG. 12.

The NIC 204 is an interface circuit for network connection with the calculation nodes 1-1 to 1-3 and various types of external electronic devices. The NIC 204 realizes the reception unit 220 and the transmission unit 222 of FIG. 12.

The storage 205 includes a readable and writable storage medium, and a driving apparatus for reading and writing various types of information, such as programs and data, from and to this storage medium. For the storage 205, a semiconductor memory, such as a hard disk and a flash memory, can be used as the storage medium. The storage 205 realizes the storage unit 21 described using FIG. 12.

The storage 205 includes a program storage region for storing a program that is intended for the aggregation node 2 to execute aggregation processing, total computation processing, and distribution processing with respect to the partial computation results from the calculation nodes 1-1 to 1-3. The storage 205 may include, for example, a backup region and the like for backing up the aforementioned data, programs, and so forth.

The I/O 206 includes a network port to which signals from external devices are input and which outputs signals to external devices. For example, network ports that correspond in number to the calculation nodes 1-1 to 1-3 can be provided. Alternatively, one network port can be provided in a case where the aggregation node 2 and the calculation nodes 1-1 to 1-3 are connected via a network switch.

The addition circuit 207 can use, for example, an addition circuit including a basic logic gate and the like. The addition circuit 207 realizes the addition unit 221 described using FIG. 12. Note that in the present embodiment, the addition circuit 207 is included in the network processing apparatus that includes the NIC 204 and the I/O 206. Furthermore, the computation apparatus includes the CPU 201, the main memory 202, the GPU 203, and the storage 205.

### Operations of Calculation Nodes

Next, the operations of the calculation nodes 1 configured in the aforementioned manner will be described using a flowchart of FIG. 14.

First, the operations of each calculation node 1 configured in the aforementioned manner will be described using the flowchart of FIG. 8. In the following description, a part of a neural network model, inputs x, and weight parameters w are loaded to the storage unit 11 in advance.

First, the computation unit 10 calculates a part of matrix products in learning of the neural network (step S1).

Next, once a partial computation result obtained by the computation unit 10 has been stored to the storage unit 11 (step S2: YES), the transmission unit 122 of the network processing unit 12A transmits a partial computation result obtained by the self-node to the aggregation node 2 (step S13). On the other hand, when the partial computation result calculated by the self-node has not been obtained (step S2: NO), computation in step S1 is executed (step S1).

Thereafter, the reception unit 120 of the network processing unit 12A receives a total computation result from the aggregation node 2 (step S14). Thereafter, the received total computation result is stored to the storage unit 11. Note that the plurality of calculation nodes 1-1 to 1-3 operate in a similar manner.

### Operations of Aggregation Node

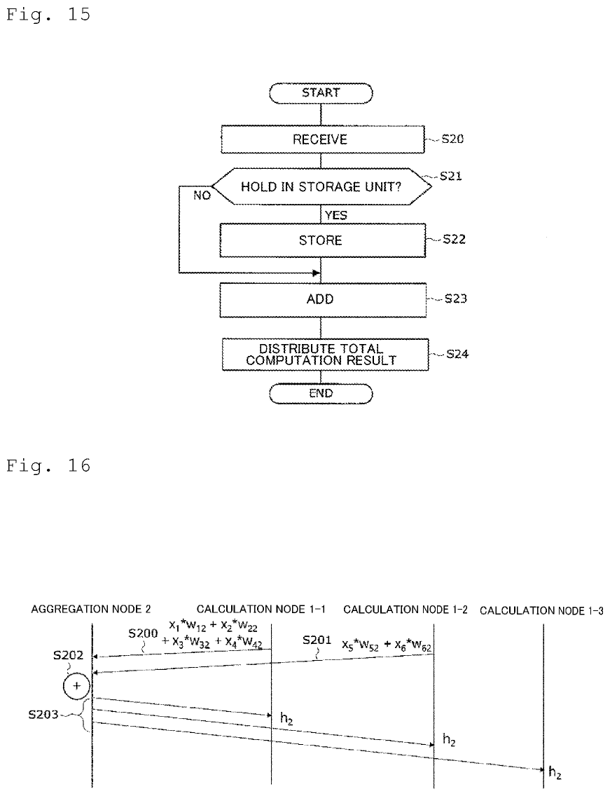

Next, the operations of the aggregation node 2 configured in the aforementioned manner will be described using a flowchart of FIG. 15.

First, the reception unit 220 receives partial computation results obtained by the plurality of calculation nodes 1-1 to 1-3 (step S20).

Next, the network processing unit 22 determines whether to hold the received partial computation results in the storage unit 21 (step S21). The determination processing of step S21 is performed when, for example, the distributed deep learning system adopts an asynchronous system in which the transmission of partial computation results to the aggregation node 2 is started as soon as partial computation in each of the plurality of calculation nodes 1-1 to 1-3 is completed.

For example, when only the partial computation result calculated by the calculation node 1-1 has been received (step S21: YES), the network processing unit 22 causes the storage unit 21 to store the partial computation result from the calculation node 1-1 (step S22). In this case, the aggregation node 2 temporarily accumulates the partial computation results that have already been received by the storage unit 21 until the completion of reception of all partial computation results that are necessary to perform group communication.

Thereafter, for example, when the partial computation result calculated by the calculation node 1-2 has been received, the network processing unit 22 determines that the partial computation result of the calculation node 1-2 is not to be stored in the storage unit 21 (step S21: NO), and transmits this partial computation result to the addition unit 221 (step S23).

The addition unit 221 reads out the partial computation result of the calculation node 1-1 stored in the storage unit 21, and obtains a total computation result, which is a sum of this partial computation result and the partial computation result from the calculation node 1-2 (step S24). Thereafter, the transmission unit 222 distributes the total computation result obtained by the addition unit 221 to the plurality of calculation nodes 1-1 to 1-3 via the communication network.

### Operations of Distributed Deep Learning System

Next, the operations of the distributed deep learning system, which includes the aggregation node 2 and the calculation nodes 1-1 to 1-3 configured in the aforementioned manner, will be described with reference to a sequence diagram of FIG. 16. Note that the following describes a case where the distributed deep learning system obtains the outputs of the hidden layer h₂, which have been described using FIG. 2 to FIG. 5.

As shown in FIG. 16, the computation unit 10 of the calculation node 1-1 obtains a partial computation result by calculating [x₁*w₁₂+x₂*w₂₂+x₃*w₃₂+x₄*w₄₂]. The transmission unit 122 of the calculation node 1-1 transmits the partial computation result to the aggregation node 2 (step S200). On the other hand, the computation unit 10 of the calculation node 1-2 obtains a partial computation result by calculating [x₅*w₅₂+x₆*w₆₂]. The calculation node 1-2 transmits the partial computation result to the aggregation node 2 (step S201).

Next, once the aggregation node 2 has received the partial computation results from the calculation nodes 1-1 and 1-2, the addition unit 221 obtains a total computation result, which is a sum of these partial computation results (step S202).

Thereafter, the aggregation node 2 distributes the total computation result, which indicates the outputs of the hidden layer h₂, from the transmission unit 222 by transmitting the same to the calculation nodes 1-1 to 1-3 (step S203).

Note that the distributed deep learning system is not limited to adopting the aforementioned asynchronous system, and can also adopt a synchronous system. In the case of the synchronous system, the plurality of calculation nodes 1-1 to 1-3 start transmitting the partial computation results to the aggregation node 2 at the timing of completion of partial computation in all of the plurality of calculation nodes 1-1 to 1-3. In this case, the processing for determining whether to store in the storage unit 21, which is performed in step S21 of FIG. 15, is skipped.

Furthermore, also in the case where the synchronous system is adopted, for example, as the outputs of the hidden layer h₂ can be obtained at the time of completion of calculations by the calculation node 1-1 and the calculation node 1-2, group communication can also be started through the aggregation of partial computation results in the aggregation node 2 without waiting for the completion of calculation by the calculation node 1-3.

As described above, according to the second embodiment, the aggregation node 2 receives partial computation results that were respectively obtained by the plurality of calculation nodes 1-1 to 1-3, and obtains a total computation result by adding these partial computation results. Also, the aggregation node 2 distributes the obtained total computation result to the plurality of calculation nodes 1-1 to 1-3 via the communication network. In the aggregation node 2, it is sufficient to perform only addition processing, and thus the computation unit 10 is unnecessary. Therefore, according to the second embodiment, coordinated processing among calculation nodes can be performed at higher speed even if the number of calculation nodes connected to the communication network increases, compared to the conventional example in which the computation unit 10 performs addition processing in the form of software.

Note that the described embodiment has exemplarily presented a case where learning is performed in the entire neural network by the plurality of calculation nodes 1-1 to 1-3 performing distributed learning with the division of the neural network model, thereby increasing the speed of group communication. However, the distributed deep learning system according to the present embodiment can increase the speed of processing not only by application to learning processing, but also by application to large-scale matrix calculation including multiply-accumulate operations for matrixes, such as inference processing.

Although the above has described embodiments of the distributed deep learning system and the distributed deep learning method of the present invention, the present invention is not limited to the described embodiments, and various types of modifications that can be envisioned by a person skilled in the art within the scope of the invention set forth in the claims can be made to the present invention.

### REFERENCE SIGNS LIST

1, 1-1, 1-2, 1-3 Calculation node
10 Computation unit
11 Storage unit
12 Network processing unit
110 Partial computation result
111 Total computation result
120 Reception unit
121 Addition unit
122 Transmission unit
101 CPU
102 Main memory
103 GPU
104 NIC
105 Storage
106 I/O

1.-7. (canceled)

8. A distributed deep learning system comprising:
a plurality of calculation nodes connected to one another via a communication network, each of the plurality of calculation nodes comprising:
a computation apparatus configured to calculate a matrix product included in computation processing of a neural network and to output a first computation result;
a first storage apparatus configured to store the first computation result output from the computation apparatus; and
a network processing apparatus comprising:
a first transmission circuit configured to transmit the first computation result stored in the first storage apparatus to another calculation node;
a first reception circuit configured to receive a first computation result from another calculation node;
an addition circuit configured to obtain a second computation result, the second computation result being a sum of the first computation result stored in the first storage apparatus and the first computation result from the another calculation node received by the first reception circuit;
a second transmission circuit configured to transmit the second computation result to another calculation node; and
a second reception circuit configured to receive the second computation result from another calculation node.

9. The distributed deep learning system according to claim 8, wherein:
the plurality of calculation nodes comprise a ring communication network; and
the network processing apparatus comprises a plurality of network ports allocated to the first transmission circuit, the first reception circuit, the second transmission circuit, and the second reception circuit, respectively.

10. The distributed deep learning system according to claim 9, wherein:
each of the plurality of calculation nodes further comprises a second storage apparatus; and
the second storage apparatus is configured to store the second computation result obtained by the addition circuit and the second computation result received from the another calculation node by the second reception circuit.

11. The distributed deep learning system according to claim 8, wherein:
each of the plurality of calculation nodes further comprises a second storage apparatus; and
the second storage apparatus is configured to store the second computation result obtained by the addition circuit and the second computation result received from the another calculation node by the second reception circuit.

12. A distributed deep learning system comprising:
a plurality of calculation nodes connected to one another via a communication network; and
an aggregation node;
wherein each of the plurality of calculation nodes comprises:
a computation apparatus configured to calculate a matrix product included in computation processing of a neural network and to output a first computation result;
a first network processing apparatus comprising:
a first transmission circuit configured to transmit the first computation result output from the computation apparatus to the aggregation node; and
a first reception circuit configured to receive a second computation result from the aggregation node, the second computation result being a sum of the first computation results calculated by the plurality of calculation nodes; and
a first storage apparatus configured to store the second computation result received by the first reception circuit; and
wherein the aggregation node comprises:
a second network processing apparatus comprising:
a second reception circuit configured to receive the first computation results from the plurality of calculation nodes;
an addition circuit configured to obtain the second computation result; and
a second transmission circuit configured to transmit the second computation result obtained by the addition circuit to the plurality of calculation nodes; and
a second storage apparatus configured to store the first computation results from the plurality of calculation nodes received by the second reception circuit; and
wherein the addition circuit is configured to read out the first computation results from the plurality of calculation nodes stored in the second storage apparatus and to obtain the second computation result.

13. The distributed deep learning system according to claim 12, wherein the plurality of calculation nodes and the aggregation node comprise a star communication network in which the plurality of calculation nodes and the aggregation node are connected to one another.

14. A distributed deep learning method executed by a distributed deep learning system comprising a plurality of calculation nodes connected to one another via a communication network, the distributed deep learning method comprising:
calculating a matrix product included in computation processing of a neural network and outputting a first computation result;
storing the first computation result to a first storage apparatus;
transmitting the first computation result stored in the first storage apparatus to another calculation node;
receiving a first computation result from another calculation node;
obtaining a second computation result, the second computation result being a sum of the first computation result stored in the first storage apparatus and the first computation result received from the another calculation node;
transmitting the second computation result to another calculation node; and
receiving a second computation result from another calculation node.

15. The distributed deep learning method according to claim 14, wherein:
the plurality of calculation nodes comprise a ring communication network; and
the network processing apparatus comprises a plurality of network ports allocated to the first transmission circuit, the first reception circuit, the second transmission circuit, and the second reception circuit, respectively.

16. The distributed deep learning method according to claim 15, further comprising storing the second computation result obtained by the addition circuit and the second computation result received from the another calculation node by the second reception circuit to a second storage apparatus.

17. The distributed deep learning method according to claim 14, further comprising storing the second computation result obtained by the addition circuit and the second computation result received from the another calculation node by the second reception circuit to a second storage apparatus.
